(19) United States
(12) Patent Application Publication
(10) Pub. No.: US 2016/0195629 A1
(43) Pub. Date: Jul. 7, 2016

(54) ACOUSTIC LOGGING TOOL

(71) Applicant: SCHLUMBERGER TECHNOLOGY CORPORATION, Sugar Land, TX (US)

(72) Inventors: Timur Vyacheslavovich ZHARNIKOV, Moscow (RU); Denis Evgenyevich SYRESYN, Kanagawa-ken (JP); Masafumi FUKUKHARA, Kanagawa (JP)

(73) Assignee: SCHLUMBERGER TECHNOLOGY CORPORATION, Sugar Land, TX (US)

(21) Appl. No.: 14/908,950

(22) PCT Filed: Jul. 17, 2014
(86) PCT No.: PCT/RU2014/000520

§ 371 Date: Jan. 29, 2016

(30) Foreign Application Priority Data
Jul. 30, 2013 (RU) 2013135667

(51) Int. Cl. G01V 1/46

(52) U.S. Cl. CPC G01V 1/46

(57) ABSTRACT

The acoustic logging tool comprises at least one emitter and at least two receivers. The receivers are installed in positions having different azimuthal coordinates and are capable of measuring a wave field at points located at different distances from a vertical axis of the tool. The receivers are installed so that it is possible to change azimuthal or radial position of the receivers during measurements or both.

### CROSS-REFERENCE TO RELATED APPLICATION

This application is a U. S. National Stage Application under 35 U.S.C. §371 of Patent Cooperation Treaty Application Number PCT/RU2014/000520 filed Jul. 17, 2014, which claims priority to Russian Patent Application No. 2013135667 filed Jul. 30, 2013. Both of these applications are incorporated herein by reference in their entireties

### BACKGROUND

The disclosure relates to systems for determining rock properties using acoustic logging.

In traditional acoustic logging tools receivers are usually spaced equidistantly along a borehole axis; often the receivers are placed at a fixed distance from a tool axis or from the borehole axis in a radial direction. Thus, V. Pistre, et. al. shows in paper “A modular wireline sonic tool for measurement of 3D (azimuthal, radial and axial) formation acoustic properties”, SPWLA 46^{th} annual logging symposium, 2005, that spatial pressure distribution in a fluid is measured by receivers disposed at a given distance from a borehole axis at points having different azimuthal and axial coordinates. This configuration allows the calculation of an arrival time of several waves propagating along the borehole axis, for example, P and S head waves and borehole modes (e.g., Stoneley or pseudo-Rayleigh wave).

Other measuring schemes used to obtain information about azimuthal dependence of the pressure are described by C. B. Vogel and R. A. Heroltz in “The CAD, a circumferential acoustical device for well logging, SPE 6819, (1977)”, and in US Patent Application Publication No. 2011/0019501. According to these publications the receivers are placed near a borehole wall and measure the azimuth pressure field distribution. This configuration is useful to obtain information about surface waves propagating along interfaces between elastic and liquid media. However, all the above devices measure pressure distribution at a fixed distance from the borehole axis or from the tool so they cannot be used to obtain information on the radial distribution of the wave field. This configuration cannot be optimal from the point of view of measurement accuracy and solution of several kinds of inverse problems (for example, for calculating dispersion properties of propagating waves, determining physical properties of a drilling mud, casing or surrounding formation), or in the case of spatial sampling and/or optimizing the number of measuring points. To date methods to measure elastic wavefield spatially (including different radii) are not available; and information about the radial distribution of fields is not used at the stage of processing the data.

### SUMMARY

In various embodiments, the disclosure provides measuring of spatial distribution of a pressure wavefield or other components of the wave field (elastic stress, strain, velocity, displacements and accelerations) along three coordinates, including at different radial distance. The use of spatially distributed receivers as logging tools can facilitate separation of the borehole modes in signals detected which can optimize the measurement and subsequent signal processing. The measuring system proposed allows the position of receivers to vary and to measure pressure and other components of the wave field (elastic stress, strain, velocity, displacements and accelerations) dependence on all three coordinates.

The disclosed acoustic logging tool comprises at least one emitter and at least two receivers; the receivers are installed in positions having different azimuthal coordinates and are capable of measuring a wave field at different distances from a vertical axis of the tool.

The receivers can be installed so that it is possible to change their azimuthal or radial position during measurements; it is also possible to change position of the receivers on the axial coordinate. Distributed receivers can be used as the receivers.

The method can be used for measuring pressure, stresses, deformations, displacements, velocities or acceleration wave fields.

According to one embodiment of the disclosure the acoustic logging tool comprises a cylindrical body and at least two pairs of arms disposed at different heights along the body; one end of each upper and each lower arm is attached to the cylinder body rotatably. In each pair, a receiver is attached to a movably connected free end of the lower end of the upper arm. The attached to the body end of at least one arm in each pair of the arms is movable along the body in the vertical direction. The vertically movable ends of the upper or the lower arms in all pairs can be disposed at the same level in the height of the body and can be rigidly interconnected. The receiver can be a distributed receiver made in the form of elastic or flexible tape with attached receivers; one end of the tape is fixed to the body and the other end of the tape is attached to the free ends of the upper and the lower arms.

According to an embodiment of the invention the attached to the body ends of the upper and the lower arms in each pair of arms are movable along the body in the vertical direction. The vertically movable ends of the upper arms or of the lower arms or both can be disposed at the same level and can be rigidly interconnected. The receiver can be a distributed receiver made in the form of an elastic or a flexible tape with attached receivers; one end of the tape is fixed to the body and the other end of the tape is attached to the free ends of the upper and the lower arms.

According to an embodiment of the disclosure, the acoustic logging tool comprises a cylindrical body and at least two arms attached to the body perpendicularly to a vertical axis of the tool at the same height along the body; each arm is attached to the body by one end and a receiver is mounted on a free end of each arm and the arms are extendable in a radial direction from a vertical axis of the tool.

According to an embodiment of the disclosure, the acoustic logging tool comprises a cylindrical body and at least two arms attached to the body; each arm is attached to the body by one end and a receiver is mounted on a free end of each arm. Each arm is disposed at an angle to a vertical axis of the tool; and are capable of extending or changing the angle between the tool axis and the arm, or both. A flexible telescopic rod can be attached to each receiver perpendicularly to the vertical axis of the tool. An opposite end of the rod is connected to the body.

In all the above embodiments distributed receivers can be used as the receivers.

According to yet another embodiment the receivers can be installed on at least two grids having different radii in points having different azimuthal and axial coordinates.

### BRIEF DESCRIPTION OF DRAWINGS

Those skilled in the art should more fully appreciate advantages of various embodiments of the present disclosure from the following “Description of Illustrative Embodiments,” discussed with reference to the drawings summarized immediately below.

FIG. 1a shows one embodiment of the disclosure for measuring pressure (velocity, acceleration, deformation, and tress).

FIG. 1b shows a receiver section and FIG. 1c shows a top view of the receiver section.

FIG. 2a shows another embodiment of the disclosure for measuring pressure (velocity, acceleration, deformation, and stress).

FIG. 2b shows a receiver section, and FIG. 2c shows a top view of the receiver section.

FIG. 3 shows an embodiment of the disclosure for measuring a wave field using a receiver mounted on an extending arm.

FIG. 4 shows an embodiment of the disclosure with a possibility of varying the radial receiver position.

FIG. 5 shows another embodiment of the invention providing measuring distribution of a wave field using a tape with receivers.

FIG. 6 shows the embodiment of the disclosure with a set of receivers.

FIG. 7 shows the embodiment of the disclosure with receivers installed on a grid.

### DETAILED DESCRIPTION

The disclosed system allows one to make measurements at any point inside a borehole. Unlike the standard measurement schemes, choosing the configuration of the spatial distribution of receivers (distribution of measurement points in radial direction, along the axis and on azimuth angle) can give the best results. From the mathematical point of view the data on the wave fields obtained in multiple locations can improve the result of solving the inverse problem. Moreover, processing signals recorded by receivers in different radial coordinates gives an opportunity to obtain information that is not available when a traditional detector configuration is used.

It is possible to vary a receiver position during logging to optimize the accuracy of measurements (e.g., through improving the signal to noise ratio) and getting additional information to calculate the wave field.

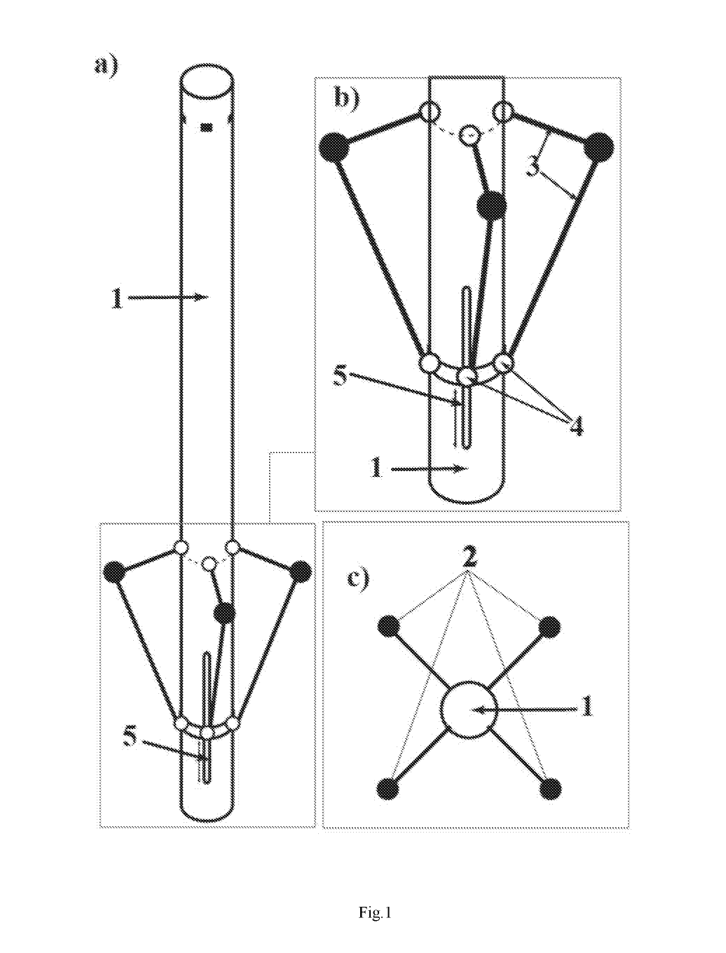

One embodiment of the disclosure is shown in FIG. 1. A module with emitters (not shown) is located at a top or bottom part of a cylindrical body 1 of the logging tool disclosed. A structure of the module and emitter characteristics can be the same or can differ from those used in traditional acoustic logging equipment. One or more receiver modules are located above or below the emitter module. Two or more (e.g., four) receivers 2, in each module measure a wave field at points having different azimuths. Each receiver 2 is attached to free ends of two movably connected arms 3 (for example, by a hinge or another type of joint providing for rotation motion). The opposite ends of the arms are attached to the body 1 using a joint element 4 providing for mobility of the arms relative to the body (for example, a hinge or other types of joint elements providing for rotation of the arms 3 and/or their mobility). In each pair of the arms, the attached to the body end of at least one arm is movable in a vertical direction along a guide rail 5 on the tool body 1 made, for example, in the form of a slit or a rail. The vertically movable ends of the arms 3 can be rigidly interconnected and move vertically together or are independent and can move independently of each other.

The process of measuring a field using this described embodiment comprises the following steps. The logging tool and its software are prepared for measurements and then the tool is placed into the borehole. The tool is moved along the borehole according to a preset algorithm and a point along the axis of the borehole is selected where the measurement of the wave field will be made. The joint elements 4 located on the guide rail 5 are driven along the guide rail, for example, using an electric motor (not shown). This move results in a change of the angle between the upper and the lower arms 3 which changes radial and axial positions of the receivers 2. The joint elements 4 are moved to such a distance that the position of the receivers 2 corresponds to the specified value. After installing the receivers 2 to the desired position an acoustic signal is emitted, wave field parameters are measured and recorded. These steps can be repeated to make measurements at points having different values of axial, radial and azimuthal coordinates. The measurements in other geometric configurations of the tool along the wellbore are made in the same manner.

Thus, this positioning system allows measurements to be performed at any distance from the tool surface to a borehole wall. In addition, it is important to ensure rotation of the module to cover all possible azimuthal angles. Moving the tool along the borehole axis allows a measuring pressure at any point in drilling mud between the surface of the tool and the borehole wall.

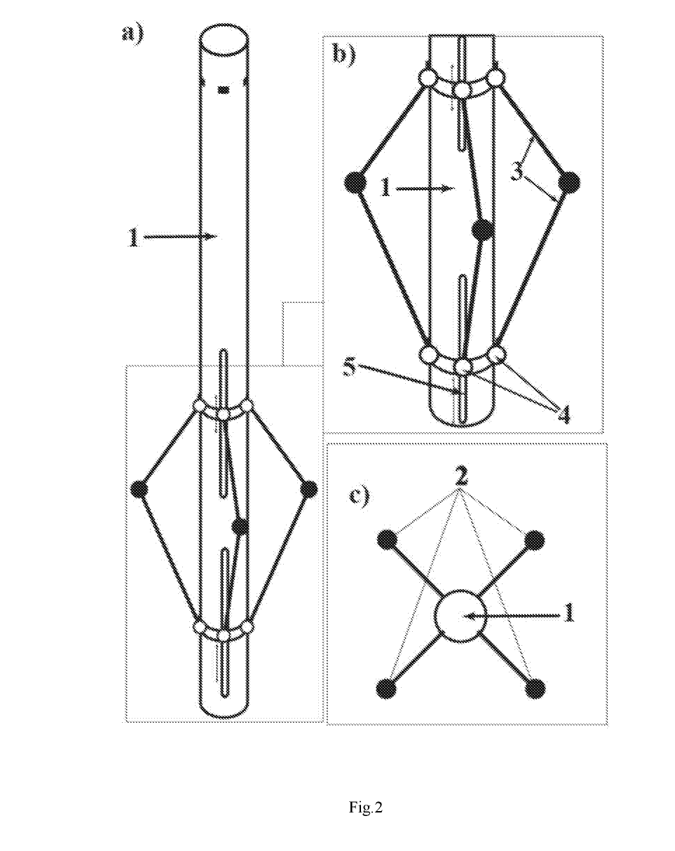

A problem of a potential change in position of the receivers along the axial coordinate due to the change of their radial position can be avoided if two movable ends of the arms 3 (see FIG. 2) disposed on an upper and a lower guide rails 5 are used to fix position of the receiver 2. To avoid strong interference between the tool and the wave field distribution the elements of the positioning system should be small in size, they should have the maximum acoustic transparency or provide for a minimum effect on acoustic waves propagating in the fluid. It should be noted that if the radial position of the receivers coincides with the radius of the tool, the logging scheme is similar to conventional schemes; in this case the tool allows for gathering the data and making analysis using an approach developed for existing logging tools.

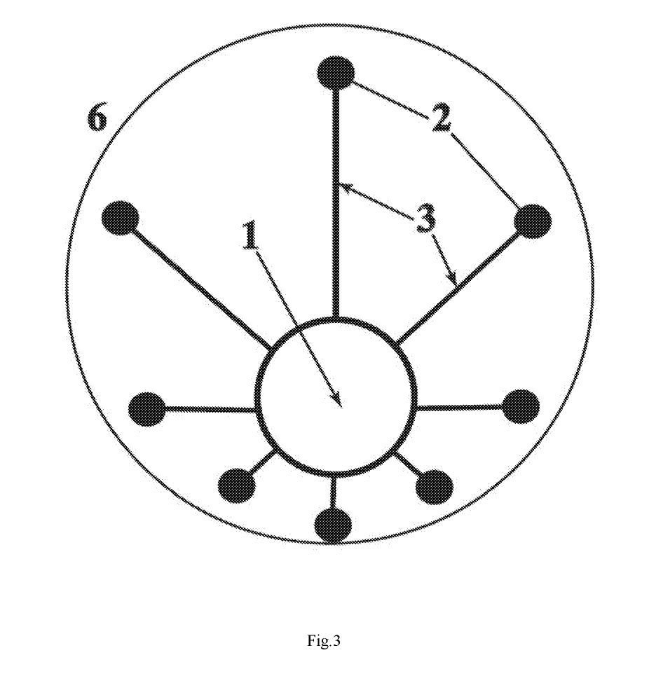

FIG. 3 shows a principle to measure a wave field using receivers 2 attached to extendable arms 3 disposed at the same height perpendicular to the tool axis. This system allows for measurements to be made at points having preset radial coordinates and at a certain distance from a borehole wall 6. Since the wave field sampling should be carried out at points having different azimuthal coordinates, a number of arms and their azimuthal position can be chosen in an arbitrary manner. The extendable arms 3 can be made as telescopic arms consisting of concentric pipes whose relative motion allows adjusting the overall length of the arm 3.

The process of measuring field using this tool is as follows. The tool is placed at the measurement point inside the borehole and the arms 3 are extended (for example, using an electric motor or a pneumatic pump). This extension can be made independently for each arm and can be accompanied by rotating the tool body and/or rotating a section of the receivers around the tool axis. Therefore, changing an angle of rotation of the receivers 2 and their distance from the axis of the tool, the receivers 2 can be installed in positions with preset coordinates (the radial, axial and azimuthal coordinates).

As soon as the receivers 2 are installed in the required position an acoustic signal is generated by an emitter and a wave field is measured and recorded. These steps can be repeated to make measurements of the field at points having different values of axial, radial and azimuthal coordinates.

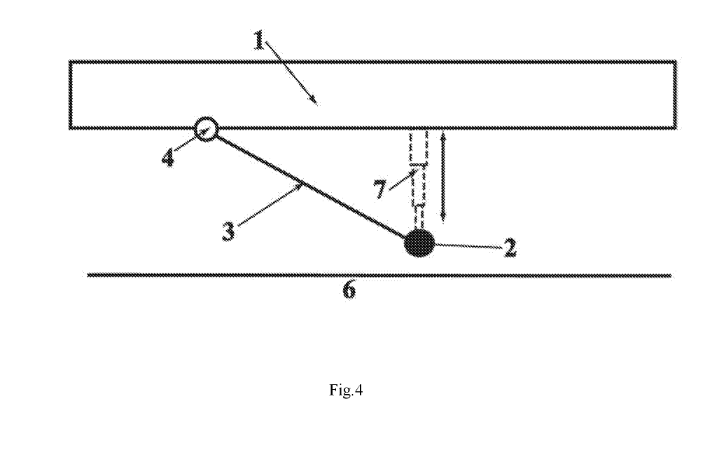

In a tool shown in FIG. 4, each receiver 2 is attached to a single extending arm 3, fixed at the surface of the body 1 using a joint element 4. An inclination angle of the arm 3 and a distance between the receiver 2 and the body 1 can be adjusted by extending a flexible arm 7 attached to the body 1. Changing a length of the arm 7 allows a radial position of the receivers 2 to be changed or to bring them into contact with a borehole wall 6. The joint element 4 can be made as a hinge and the arm 7 can be a flexible telescopic rod, a length of which can be adjusted, for example, by a pneumatic pump. The angle between the tool axis and the arm 3 is adjusted by changing the length of the arm 7. This approach allows a radial position of the receivers 2 to change as well as to bring them into contact with the borehole wall 6. This embodiment changes the angle between the arm 3 and the axis of the tool without extending the arm, to extend the arm 3 without changing the angle between the arm 3 and the axis of the tool; it is also possible to change the angle and to extend the arm simultaneously.

The process of measuring a field using this tool is as follows. As soon as the tool is placed in the borehole at the measurement point, the arms 7 are extended (using, for example, an electric motor or a pneumatic pump). The extension leads to a change of the angle between arm 3 and body 1. This allows the control of a radial position of the receiver 2 attached to the end of the arm 3 and to change a radial and axial positions of the receivers 2.

As soon as the receivers 2 are installed to the desired position an acoustic signal is generated by an emitter and the wave field is measured. These steps can be repeated to measure the field at points having different values of the axial, radial and azimuthal coordinates.

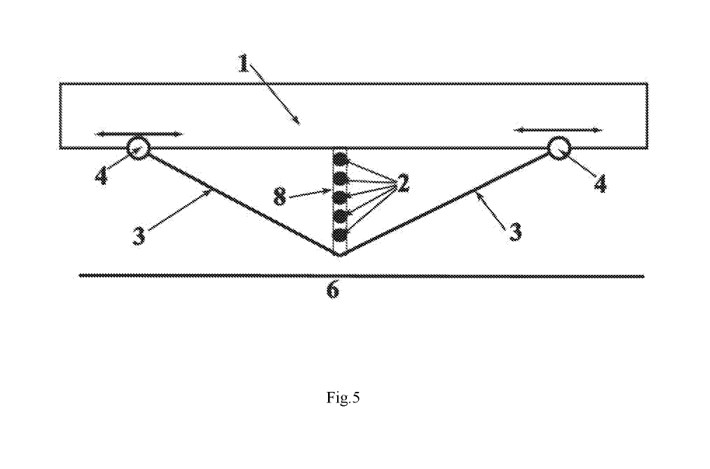

It is possible to use an elastic or flexible tape 8 with receivers 2; the tape extends from a surface of the body 1 to a point with a selected radial position (see FIG. 5). Thus, it is possible to set multiple receivers at points with different radii and to increase, thereby, a number and an accuracy of data. It should be noted that an array of receivers can be placed on the extendable tape or next to it. The described receiver distribution can be applied for each example featuring extendable arms.

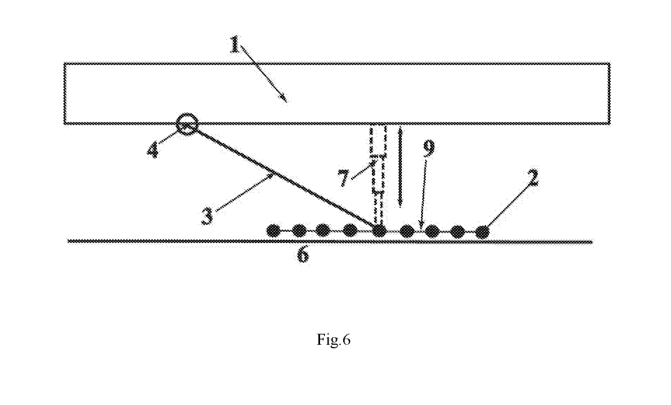

FIG. 6 shows a block 9 of receivers 2 attached to an extendable arm 3. One end of the arm 3 is movably attached to a body 1 of the tool by a joint element 4, the opposite end is attached to the block 9 of the receivers. An inclination angle of the arm 3 and a distance between the block 9 and a borehole wall 6 can be changed by changing a length of an extendable flexible arm 7 attached to the block 9 and to the body 1. This embodiment can be used to measure formation/casing defects or to calculate anisotropic reservoir properties by pressing the block 9 to the borehole wall 6. The block 9 of the receivers 2 can be made as a rigid rod or as a plate, straight or curved. When the block 9 is made as a rod, at least two receivers 2 are rigidly fixed along the rod at a fixed distance from each other. When the block 9 is made as a plate, at least two receivers 2 are fixed in the plane of the plate at a fixed distance from each other. The inclination angle of the arm 3 and the distance between the block 9 and the wall 6 of the borehole are controlled by extending the arm 7. The arm 7 can be a flexible telescopic rod with a length that can be adjusted using, for example, a pneumatic pump.

The measurements using the tool are carried out as follows. The tool is installed in the borehole at the point of measurement and the arms 7 are extended (for example, by using an electric motor or a pneumatic pump). The extension leads to a change of the angle between the arm 3 and the body 1. This allows control of a radial position of block 9 of the receivers 2 attached to the end of the arm 3 and to change radial and axial positions of the receivers 2 until the block 9 is pressed against the borehole wall 6.

When the block 9 of the detectors 2 is installed in the required position an acoustic signal is emitted and the wave field is measured.

These steps can be repeated to measure the field at points having different values of axial, radial and azimuthal coordinates.

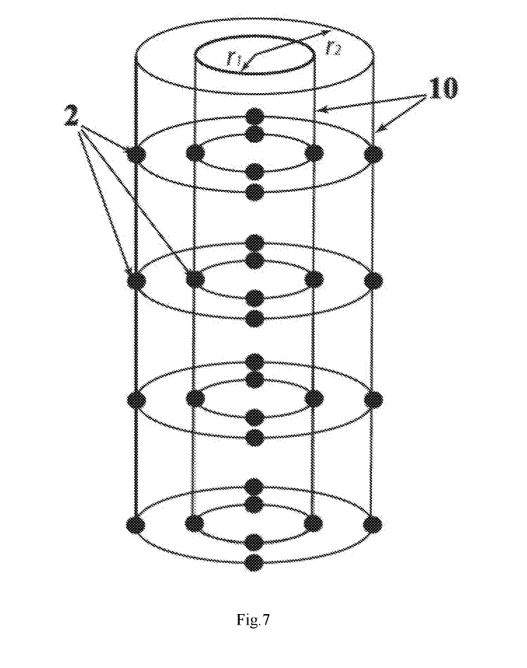

FIG. 7 shows an embodiment providing wave field measuring at points having different radial, axial and azimuthal coordinates. Receivers 2 are arranged in a manner that a certain part of all detectors 2 is located on one of at least two grids 10 having radii r₁ or r₂ (or rᵢ, where i is a natural number) at the points having different azimuthal and axial coordinates. The reminder of the receivers 2 is disposed on the other grid(s). A ratio of the receivers located on each grid to the total number of the receivers can vary. The same number of the receivers 2 can be disposed on each grid to ensure that the measurements are taken at points having similar axial and azimuthal coordinates for each grid. A role of the grid having a minimum radius r₁ can be performed by a tool casing similar to standard logging tools.

The tool has no moving parts which provides for better reliability than in the tools having extended arms. Moreover, the relevant points in the grids can be connected using a tape with receivers (similar to the situation shown in FIG. 5). The main difference between this measurement process and the measuring algorithm in standard acoustic logging tools is that a bigger scope of data is obtained when the wave fields are measured using the receivers 2 located at different distances from the tool.

An example of an algorithm to restore the pressure field in liquid is given below; this algorithm can apply to the embodiments shown in FIGS. 1, 2, 3, 4 and 7. This approach determines certain physical parameters relating to properties of propagating waves (azimuthal and axial wave numbers n and k) and to elastic parameters of a drilling mud (e.g., a wave velocity in the drilling mud C_{(f)}). It should be noted that C_{f} cannot be determined if there is no information on pressure field at points having different radial coordinates. This implies that the measurements should be made at different radii to get the optimum analysis of the wave field.

Let's consider a model of a borehole penetrating a sandstone formation and filled with a fluid. The borehole has a radius 0.1 m and geometric and elastic parameters have the following values:

Water: density ρ_{f}=1000 kg/m³; wave velocity C_{f}=1500 m/s;
Sandstone: density ρ_{f}=2200 kg/m³; velocity of shear waves Cₜ=1840 m/s; velocity of longitudinal waves Cₜ=2920 m/s.

The pressure is measured in at least four points of the fluid having the following coordinates: (r₁,θ₁,z₁), (r₂,θ₂,z₂), (r₁,θ₁,z₂), (r₁,θ₂,z₁). If one of the normal modes propagating in the borehole dominates in a signal, a pressure value can be represented as follows:

P₁(r₁,θ₁,z₁)=Alₙ(βr₁)e^{i(nθ}^{₁}^{+kz}^{₁}^{-wt)},

P₂(r₂,θ₂,z₂)=Alₙ(βr₁)e^{i(nθ}^{₂}^{+kz}^{₂}^{-wt)},

P₃(r₁,θ₁,z₂)=Alₙ(βr₁)e^{i(nθ}^{₁}^{+kz}^{₂}^{-wt)},

P₄(r₁,θ₂,z₁)=Alₙ(βr₁)e^{i(nθ}^{₂}^{+kz}^{₁}^{-wt)},

where n—an azimuthal wavenumber of the mode selected, k—an axial wavenumber, β=\sqrt{k²−k_{f}²}, k_{f}=ω/C_{f}—a fluid wavenumber, lₙ(x)—modified Bessel function, A—a scalar constant depending on source function. Selecting two different points it is possible to derive various physical properties in the following way:

$$a ) If {r}_{1} = {r}_{2} , {θ}_{1} = {θ}_{2} and {z}_{1} \neq {z}_{2} + \frac{2 π l}{k} \text{:} \frac{{P}_{1} ( {r}_{1} , {θ}_{1} , {z}_{1} )}{{P}_{3} ( {r}_{1} , {θ}_{1} , {z}_{2} )} = {e}^{i k ( {z}_{1} - {z}_{2} )} .$$

By solving this equation it is possible to obtain the value of the wavenumber k (or a value inverse to velocity along the borehole axis).

$$b ) If {r}_{1} = {r}_{2} , {z}_{1} = {z}_{2} and {θ}_{1} \neq {θ}_{2} + \frac{2 π l}{n} \text{:} \frac{{P}_{1} ( {r}_{1} , {θ}_{1} , {z}_{1} )}{{P}_{4} ( {r}_{1} , {θ}_{2} , {z}_{1} )} = {e}^{i n ( {θ}_{1} - {θ}_{2} )} .$$

By solving this equation the value of n is obtained.

$$c ) If {r}_{1} \neq {r}_{2} and \frac{{I}_{n} ( β {r}_{1} )}{{I}_{n} ( β {r}_{2} )} \neq 1 \text{:} \frac{{P}_{1} ( {r}_{1} , {θ}_{1} , {z}_{1} )}{{P}_{2} ( {r}_{2} , {θ}_{2} , {z}_{2} )} = {e}^{i ( n ( {θ}_{1} - {θ}_{2} ) + k ( {z}_{1} - {z}_{2} ) )} \frac{{I}_{n} ( β {r}_{1} )}{{I}_{n} ( β {r}_{2} )} or \frac{{P}_{1} ( {r}_{1} , {θ}_{1} , {z}_{1} ) {P}_{3} ( {r}_{1} , {θ}_{1} , {z}_{2} )}{{P}_{1} ( {r}_{1} , {θ}_{1} , {z}_{1} ) {P}_{2} ( {r}_{2} , {θ}_{2} , {z}_{2} )} = F ( β ) .$$

Solving this equation we obtain the value of β or (C)_{(f)}. In contrast to conventional logging tools where calculation of the sound velocity in a drilling mud is quite challenging, the method disclosed calculates the sound velocity using data from two receivers.
d) Entering the values obtained for k, n and b into the formula for pressure in the fluid we derive the formula to calculate pressure at any point (rₓ,θₓ,zₓ) of the fluid:

$$P ( {r}_{x} , {θ}_{x} , {z}_{x} ) = {P}_{1} ( {r}_{1} , {θ}_{1} , {z}_{1} ) {e}^{i ( n ( {θ}_{x} - {θ}_{1} ) + k ( {z}_{x} - {z}_{1} ) )} \frac{{I}_{n} ( β {r}_{x} )}{{I}_{n} ( β {r}_{1} )} .$$

Therefore, to restore the full wave field formed by a signal of a well mode it is sufficient to know the pressure value at one point and n, k and β values which can be calculated from the data obtained at the other three points. This means that information on pressure at four points having specified coordinates is sufficient to restore the entire field corresponding to the propagating mode. Despite the fact that four points are sufficient to predict the pressure field, increasing the number of measurement points avoids the effect of solution periodicity and provides for more accurate results. Further, the algorithm calculates the sound velocity in a drilling mud.

It can seen that the algorithm is applicable only when certain conditions on point positions are met (for example,

$$a {z}_{1} \neq {z}_{2} + \frac{2 π l}{k} ) .$$

This is caused by periodical dependence of pressure distribution on all three coordinates. This periodicity should be avoided during the measurements.

The measurement of the wave field by spatially distributed receivers can be useful in situations of anisotropic formations and non-ideal boreholes (for example, oval boreholes) due to more careful analysis of the data obtained from radial sampling of the pressure.

1. An acoustic logging tool comprising:
at least one emitter and at least two receivers, the receivers are installed in positions having different azimuthal coordinates and are capable of measuring a wave field at points located at different distances from a vertical axis of the tool.

2. The acoustic logging tool of claim 1, wherein the receivers are installed so that it is possible to change an azimuthal position of the receivers during measurements.

3. The acoustic logging tool of claim 1, wherein the receivers are installed so that it is possible to change a radial position of the receivers during measurements.

4. The acoustic logging of claim 1, wherein the receivers are installed so that it is possible to change position of the at least receivers on an axial coordinate during measurements.

5. The acoustic logging of claim 1, wherein the receivers are distributed receivers.

6. The acoustic logging tool of claim 1, wherein the wave field being measured is a pressure wave field or a strain wave field, or an offset wave field, or a velocity wave field, or an acceleration wave field.

7. The acoustic logging tool of claim 1 comprising:
a cylindrical body,
at least two pairs of arms disposed at different heights along the body, one end of each upper arm and each lower arm is rotatably attached to the body,
the receiver attached to movably connected free ends of the upper and the lower arms in each pair,
the attached to the body end of at least one arm in each pair of the arms is movable along the body in vertical direction.

8. The acoustic logging tool of claim 7, wherein the attached to the body end of the upper arm in each pair is vertically movable and the vertically movable ends of the upper arms are installed at the same level in height of the body and are rigidly interconnected.

9. The acoustic logging tool of claim 7, wherein the attached to the body end of the lower arm in each pair is vertically movable and the vertically movable ends of the lower arms are installed at the same level in height of the body and are rigidly interconnected.

10. The acoustic logging tool of claim 7, wherein the receiver is a distributed receiver made in the form of an elastic or a flexible tape with attached receivers, one end of the tape is fixed to the body and the other end of the tape is attached to the free ends of the upper and the lower arms.

11. The acoustic logging tool of claim 7, wherein in each pair of the arms the attached to the body ends of the upper and lower arms are vertically movable.

12. The acoustic logging tool of claim 11, wherein the ends of the upper arms in all pairs are installed at the same level in height of the body and are rigidly interconnected.

13. The acoustic logging tool of claim 11, wherein the ends of the bottom arms in all pairs are installed at the same level in height of the body and are rigidly interconnected.

14. The acoustic logging tool of claim 11, wherein the ends of the upper arms in all pairs are installed at the same level in height of the body and are rigidly interconnected and the ends of the bottom arms in all pairs are installed at the same level in height of the body and are rigidly interconnected.

15. The acoustic logging of claim 11, wherein the receiver is a distributed receiver made in the form of an elastic or a flexible tape with attached receivers, one end of the tape is attached to the body and the other end of the tape is attached to the free ends of the upper and the lower arms.

16. The acoustic logging tool of claim 1 comprising:
a cylindrical body,
at least two arms attached to the body perpendicularly to a vertical axis of the tool at the same height along the body, each arm is attached to the body by one end,
a receiver attached to a free end of each arm, and
each arm is extendable in radial direction from a vertical axis of the tool.

17. The acoustic logging tool of claim 1 comprising:
a cylindrical body,
at least two arms attached to the body, each arm is attached to the body by one end,
a receiver attached to a free end of each arm,
each arm is disposed at an angle to a vertical axis of the tool and is extendable or capable of changing the angle between the vertical axis of the tool and the arm, or both.

18. The acoustic logging tool of claim 17, wherein a flexible telescopic rod is attached to each receiver perpendicular to the vertical axis of the tool, the opposite end of the rod is attached to the body.

19. The acoustic logging tool of claim 17, wherein the receiver is the distributed receiver.

20. The acoustic logging tool of claim 19, wherein the distributed receiver is made in the form of a rod and at least two receivers are rigidly fixed along the rod at a fixed distance from each other.

21. The acoustic logging tool of claim 18, wherein a length of the flexible telescopic rod is adjusted using a pneumatic pump.

22. The acoustic logging tool of claim 18, wherein a length of the flexible telescopic rod is adjusted using an electric motor.

23. The acoustic logging tool of claim 1, wherein the receivers are installed on at least two grids having different radii at points having different azimuthal and axial coordinates.
